(19) United States
(12) Patent Application Publication
(10) Pub. No.: US 2025/0352913 A1
(43) Pub. Date: Nov. 20, 2025

(54) INFORMATION PROCESSING DEVICE, COMPUTER-READABLE STORAGE MEDIUM, AND MATCH-MAKING SYSTEM

(71) Applicant: BANDAI CO., LTD, Tokyo (JP)

(72) Inventor: Yusaku KUBOTA, Tokyo (JP)

(21) Appl. No.: 19/289,093

(22) Filed: Aug. 3, 2025

Related U.S. Application Data
(63) Continuation of application No. PCT/JP2024/000442, filed on Jan. 11, 2024.

(30) Foreign Application Priority Data
Feb. 7, 2023 (JP) 2023-017188

(51) Int. Cl. A63F 13/795; A63F 13/497; A63F 13/52; A63F 13/55; A63F 13/86

(52) U.S. Cl. CPC A63F 13/795; A63F 13/497; A63F 13/52; A63F 13/55; A63F 13/86

(57) ABSTRACT

An information processing device executes: a display control process of displaying a virtual space in which virtual characters associated with users are movably placed and in which a match-making for a game in which a plurality of users participate is possible; and a control process of, subject to an establishment of a match-making in the virtual space, triggering execution of the game, wherein a virtual monitor is placed in the virtual space; and in the display control process, a video regarding the game is displayed through the virtual monitor.

The contents of the following patent application(s) are incorporated herein by reference: NO. 2023-017188 filed in JP on Feb. 7, 2023 NO. PCT/JP2024/000442 filed in WO on Jan. 11, 2024.

### BACKGROUND

### 1. Technical Field

The present invention relates to an information processing device, a computer-readable storage medium, and a match-making system, and more particularly, a match-making service for a game using a virtual space.

### 2. Related Art

There is a match-making system which performs a match-making for players concerning a battle game executed by an external service through a virtual space (Patent Document 1). The match-making system according to Patent Document 1 also includes a spectating function for accepting spectating a battle game started using the match-making system by other users who are not playing the battle game. According to the spectating function, subject to an operation to a table in a virtual space used in the match-making for the battle game being performed, a forwarding operation to a connection destination in an external service for spectating the battle game is performed, and then the users can spectate the intended battle game.

### RELATED ART DOCUMENTS

### Patent Document

Patent Document 1: Japanese Patent Application Publication No. 2022-078744

### BRIEF DESCRIPTION OF THE DRAWINGS

FIG. 1 illustrates a configuration of a match-making system according to embodiments and variants of the present invention;

FIG. 2 illustrates a hardware configuration of a user terminal 100 according to embodiments and variants of the present invention;

FIG. 3 illustrates a hardware configuration of a server 200 according to embodiments and variants of the present invention;

FIG. 4 illustrates an avatar used in a match-making service according to embodiments and variants of the present invention;

FIG. 5 illustrates an entrance room in the match-making service according to embodiments and variants of the present invention;

FIG. 6 illustrates an example screen being displayed for selecting a battle room as a transition destination according to embodiments and variants of the present invention;

FIG. 7 illustrates a normal battle room in the match-making service according to embodiments and variants of the present invention;

FIG. 8 illustrates a special battle room in the match-making service according to embodiments and variants of the present invention;

FIG. 9A describes a match-making in the battle room according to embodiments and variants of the present invention;

FIG. 9B describes a match-making in the battle room according to embodiments and variants of the present invention;

FIG. 9C describes a match-making in the battle room according to embodiments and variants of the present invention;

FIG. 10A illustrates a play screen of the battle game according to embodiments and variants of the present invention;

FIG. 10B illustrates a play screen of the battle game according to embodiments and variants of the present invention;

FIG. 11A illustrates a view in the special battle room according to embodiments and variants of the present invention;

FIG. 11B illustrates a view in the special battle room according to embodiments and variants of the present invention;

FIG. 12 illustrates an emote function in the match-making service according to embodiments and variants of the present invention;

FIG. 13 is a flowchart illustrating an entrance process executed in the user terminal 100 according to embodiments and variants of the present invention;

FIG. 14 is a flowchart illustrating a guidance process executed in a server 200 according to embodiments and variants of the present invention; and

FIG. 15 is a flowchart illustrating a monitor display process executed in the user terminal 100 according to embodiments and variants of the present invention.

### DESCRIPTION OF EXEMPLARY EMBODIMENTS

### Embodiment 1

Embodiments will be described below with reference to the accompanying drawings.

Note that the embodiments below are not intended to limit the invention according to the claims, or not all of the combinations of features described in the embodiments are necessarily essential to the invention. Two or more features of a plurality of features described in the embodiments may be combined in any way. Furthermore, same or similar configurations are given a same reference numeral, and redundant descriptions are omitted.

In an embodiment described below, an example will be described, where the present invention is applied to a system in which a server, which has accepted a connection from an information processing device, i.e., a user terminal, used by a user, provides a service establishing a match-making for a two-player battle game provided in an external service through a virtual space, as an example of a match-making system. However, the present invention is applicable to a system built by any equipment configuration in which a match-making for a game participated in by a plurality of users can be performed through a virtual space and execution of the game can be triggered.

Furthermore, as used herein, the term “user” is described as referring to a user who uses a service provided by a server 200 in the present match-making system, i.e., the match-making service. Also for convenience, a user for whom a match-making has been established in a virtual space and the gameplay is in progress may be referred to as a “player”, whereas a user for whom the gameplay is not in progress may be referred to as a “spectator”.

### «Configuration of Match-Making System»

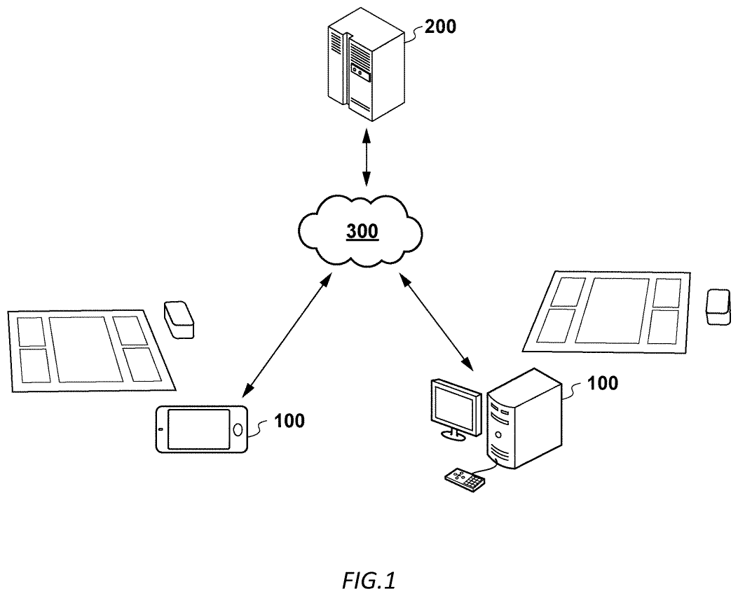

FIG. 1 illustrates a configuration of a match-making system according to the present embodiment. As shown, the match-making system is configured such that a server 200 and a plurality of user terminals 100 are communicatively connectable to each other over a network 300. Furthermore, in the present embodiment, the server 200 provides a match-making service in which a match-making for a user of a connected user terminal 100 as a player of a battle game implemented by an external service is established and execution of the battle game is triggered.

The external service will be described below as a service that assists execution of a battle game between remote players and that does not have a match-making function of a free match-making type, in which an appropriate number of players are extracted to establish a match-making between them when the service is provisioned. In the present embodiment, the external service is assumed to be a service implementing gameplay of a trading card game (TCG), where a number of players required for a battle game access, by means of their user terminals 100, a room, i.e., a connection destination, created by a host player, to enable a video chat function making use of cameras and microphones in the user terminals 100 to be available, and then statuses of game items deployed in an environment where the players exist, i.e., the real world, are shared between players as the game progresses. Thus, each of the user terminals 100 can be a PC or a smartphone equipped with a camera and a microphone.

A user of the match-making service can log into the service using their user terminal 100 to make a service available that involves presentation of the virtual space in which an avatar corresponding to the user, i.e., an operable avatar, is placed, details of which will be described below. The match-making service is a Web service accessible via a browsing application (hereinafter, simply referred to as a browser), and the service log-in is performed by completing a procedure concerning user authentication in a particular Web page. The user can perform every kind of operation input to move an operable avatar placed in the virtual space, to communicate, such as by text chat, with another user through avatars, and to establish a match-making for a battle game provided by an external service with an opponent.

### <Hardware Configuration of User Terminal>

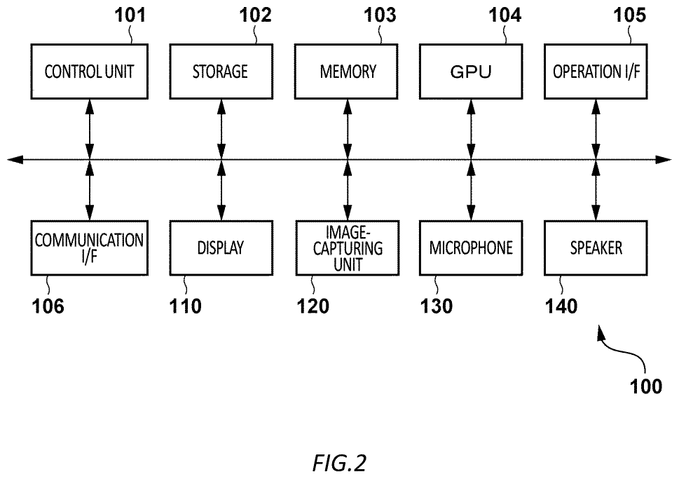

Next, a hardware configuration of the user terminal 100 will be described with reference to FIG. 2. FIG. 2 is a block diagram illustrating the hardware configuration of the user terminal 100.

A control unit 101 is a processor such as a CPU and performs every kind of control including an operational control for each piece of hardware included in the user terminal 100. Specifically, the control unit 101 performs an appropriate control, for example, by reading a necessary program stored in a storage 102 and deploying it on a memory 103 to be executed.

The storage 102 is a device that is able to permanently store information, such as a non-volatile memory, an HDD, or the like. The storage 102 stores not only an operating system for operating the user terminal 100 or programs concerning every kind of application, but also information on parameters required to achieve every kind of control as well as every kind of data used for a view concerning the browser and for a communication function. The memory 103 is a storage used to temporarily store data, such as a volatile memory or the like. The memory 103 may be used not only as a deployment region for each program, but also as a storage region to temporarily store data output on the course of operations of every kind of hardware and every kind of control, etc.

A GPU 104 is a rendering device which executes every kind of rendering process concerning generation of the display screen concerning the user terminal 100. The GPU 104 also executes a rendering process for the screen concerning a virtual space presented in the browser during the use of the match-making service. The GPU 104 includes a GPU memory not shown, which deploys every kind of graphics data read from the storage 102 and performs a predetermined operation to generate every kind of image including the screen. The screen or image generated by the GPU 104 is presented to the user by, for example, being displayed on a display 110 included in the user terminal 100. The display 110 is a device to display information, which is included in the user terminal 100 or detachably connected to the user terminal 100, such as a liquid crystal display or the like. The display 110 displays a screen generated by the GPU 104.

The operation I/F 105 is a user interface included in the user terminal 100, which accepts an operation input. When the operation I/F 105 detects that an operation input is performed, it outputs, to the control unit 101, a control signal corresponding to the operation input. In one aspect, for example, the operation I/F 105 includes an operation member such as a button provided on an exterior of the user terminal 100, every kind of sensor, or the like. Furthermore, the display 110 included in the user terminal 100 of the present embodiment is configured to be able to detect a touch input, and the operation I/F 105 includes a touch input detection sensor provided on the display 110.

A communication I/F 106 is a communication interface included in the user terminal 100, to an external device. Information communication between the communication I/F 106 and the external device may be made through a wide area network (WAN) such as the Internet, or may be made through a LAN or the like. Although the information communication made by the communication I/F 106 is described as being made in a wireless manner, it is not intended to exclude aspects made in a wired manner.

An image-capturing unit 120 is a unit including an image-capturing device having an image-capturing element such as a CCD, a CMOS sensor, or the like. The image-capturing unit 120, while a battle game concerning an external service is being played, intermittently captures a game card placed within an image-capturing range by the user and outputs a captured image, the details of which will be described below.

A microphone 130 is a voice input interface included in the user terminal 100. In the present embodiment, since the battle game according to the external service triggered by the match-making service is described as a TCG, the microphone 130 acquires a voice concerning a declaration by a player, reading aloud an effect of a game card, or the like. Furthermore, a speaker 140 is a voice output interface included in the user terminal 100. The speaker 140 outputs a voice concerning the match-making service or a voice concerning the battle game (such as a declaration by an opponent player or a sound effect).

### <Hardware Configuration of Server>

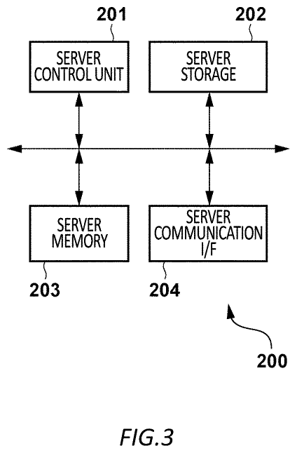

FIG. 3 is a block diagram illustrating a hardware configuration of the server 200 according to the present embodiment. Note that, in the description below, hardware configurations to implement functions similar to those in the user terminal 100 are attached with the word “server” as a prefix character in order to distinguish them from the configurations in the user terminal 100.

A server control unit 201 is a processor such as a CPU and performs controls concerning implementing: operational controls for each piece of hardware included in the server 200; user management concerning the match-making service; and every kind of function including a match-making function for users. Specifically, the server control unit 201 performs an appropriate control, for example, by reading a necessary program stored in a server storage 202 and deploying it on a server memory 203 to be executed.

The server storage 202 is a device that is able to permanently store information, such as a non-volatile memory, an HDD, or the like. The server storage 202 stores not only an operating system for operating the server 200 or programs concerning a match-making, but also information on parameters required to implement every kind of control as well as every kind of data required to provide a match-making function. Furthermore, the server storage 202 also includes a database function for managing information on each player registered as a user of the match-making system. The server memory 203 is a storage used to temporarily store data, such as a volatile memory or the like. The server memory 203 may be used not only as a deployment region for each program, but also as a storage region to temporarily store data output on the course of operations of every kind of hardware and every kind of control, etc.

A server communication I/F 204 is a communication interface included in the server 200, to an external device. Information communication between the server communication I/F 204 and the external device may be made through a wide area network (WAN) such as the Internet, or may be made through a LAN or the like. The information communication performed by the server communication I/F 204 may be made in either a wired manner or a wireless manner.

### «Overview of the Match-Making Service»

An overview of the match-making service provided in the match-making system of the present embodiment will be described below with reference to drawings.

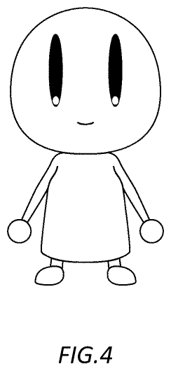

As described above, the match-making service becomes available when the browser is started in the user terminal 100 used by each user to access the Web page concerning the service to log into the service. Upon logging into the service, a virtual space represented in three-dimensional computer graphics is displayed on each user terminal 100. In the virtual space, an avatar associated with each user in the form of a three-dimensional model as illustrated in FIG. 4 (hereinafter, referred to as an operable avatar), is assigned to the user. Each user can perform an operation input concerning a movement to move the operable avatar associated with them within the virtual space. In the present embodiment, the virtual space is constructed as, for example, a three-dimensional space of a chamber-like shape, and thus hereinafter, the virtual space will be referred to as a “room”. Therefore, the operable avatar moves around within the room in response to an operation input by the user. The room is constructed as a space with a certain size, and in order to bring about an effect of the operable avatar moving around the space, for example, up-and-down motion of at least a part of an element (e.g., a trunk part) constituting the three-dimensional model for the operable avatar may be displayed during the movement of the operable avatar.

In the match-making service of the present embodiment, a plurality of types of virtual spaces are provided, and each user can go back and forth between the virtual spaces depending on an application to receive the provision of the service. That is, the operable avatar of the user is managed at the server 200 such that the operable avatar is placed in only one virtual space at a time.

The virtual spaces used in the match-making service are roughly classified as an entrance room and a battle room. A match-making between users occurs when their operable avatars are placed in a battle room. Since there is an upper limit number for a number of avatars being able to be placed and managed within one battle room, a plurality of battle rooms may be provided in parallel so as to be able to accommodate many users when they connect simultaneously. Therefore, the entrance room is provided as a virtual space in which a battle room for the operable avatar to be placed is selected. The movement between rooms, i.e., a transition, occurs when, in response to an operation input concerning the transition being performed in each room, a corresponding request is transmitted from the user terminal 100 to the server 200 and management information of the user is changed at the server 200. In the description below, a state where a particular room is assigned to a user and their operable avatar is placed in a three-dimensional space concerning the particular room, may be expressed as that the user has “entered” the particular room.

### <Entrance Room>

In the entrance room, each user can customize an appearance of their operable avatar. For the operable avatar, rendering elements constituting the appearance, for example, a color of the avatar, an item to wear on such as their head or trunk, or the like, can be made different from each other. In the entrance room, for example, each user can select an item to wear from a list of items they possess to change the appearance of their operable avatar.

Since some user does not want other users to see how the appearance of their operable avatar is changed, in the entrance room, no avatar other than the operable avatar the user uses is displayed. That is, the user can change the appearance of their operable avatar without being worried about other users' gaze or being rushed, and move the operable avatar, with the appearance set as desired, into a battle room.

Although a number of operable avatars displayed in the entrance room is one, it is inefficient to provide and manage a separate virtual space (entrance room) for each user at the server 200. Therefore, each user is provided with a view of a virtual space in which only one operable avatar is placed, whereas management of the virtual space at the server 200 is such that the virtual space is managed as one entrance room, including information on a plurality of users together. That is, the server 200 assigns a same entrance room to a plurality of users who logged into the service during a same period, but a presentation of the entrance room at each user terminal 100 is such that information on other users to whom the same room is assigned is not shared and each user is provided with a virtual space in which only their operable avatar is displayed. Thus, in the entrance room, a function such as for performing a match-making with another user is not provided, nor is execution of a battle game triggered.

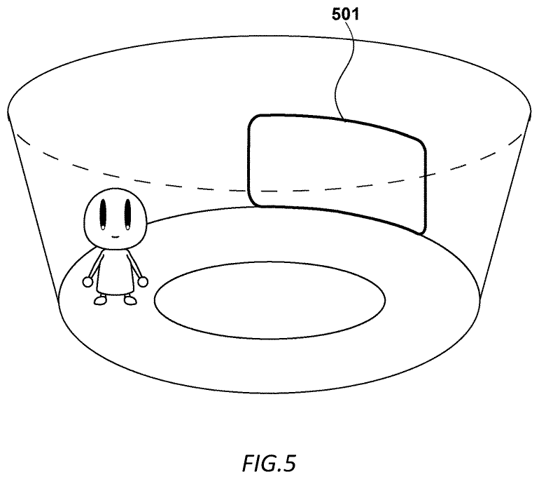

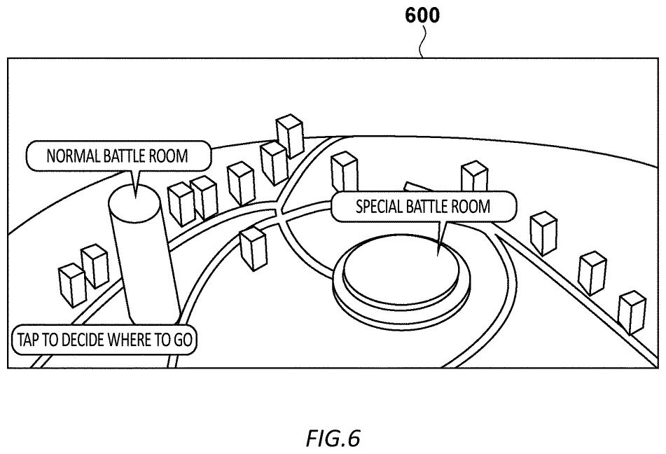

The entrance room is provided as a closed space, for example, as illustrated in FIG. 5. A window object 501 is placed in the entrance room, and a user can perform an operation input concerning a movement to move their operable avatar near the window object 501. When the operable avatar is placed near the window object 501 (e.g., within a predetermined distance), a view on the user terminal 100 is switched to a view concerning scenery outside the window as in FIG. 6, i.e., a destination selection image 600. In the match-making service of the present embodiment, the entrance room and the battle room are provided with a setting that they are each a separate facility existing in one vast game space, and through the window object 501 in the entrance room, a panoramic view of the game space can be seen in a simulated manner as illustrated in FIG. 6.

As shown, the destination selection image 600 includes an image of facilities imitating the battle rooms, and a user can perform an operation input concerning a selection of a facility as a destination, to transmit, to the server 200, a placement request to place their operable avatar into the battle room. For the battle rooms in the present embodiment, a “normal battle room” and a “special battle room” are provided as described below, and a user can select one of them from the destination selection image 600 displayed through the window object 501 in the entrance room to issue a placement request to place the operable avatar into an appropriate virtual space. Each battle room will be described below.

### (Normal Battle Room)

The normal battle room is a virtual space in which all users can generally perform match-makings concerning the battle games in the match-making service. Unlike the entrance room, within the normal battle room, not only the operable avatar but also avatars of other users who have entered the same room are placed. A user who has entered the normal battle room can move their operable avatar within the normal battle room by an operation input concerning a movement.

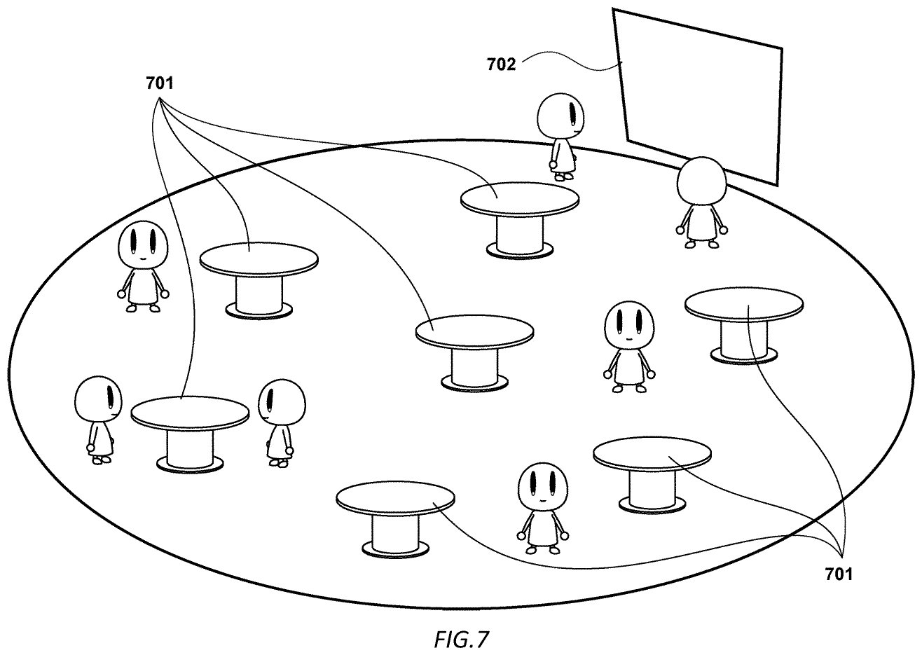

As illustrated in FIG. 7, a plurality of table objects 701 are placed in the normal battle room, and a user who desires a match-making moves their operable avatar near one of the table objects 701 to enable every kind of procedure concerning the match-making. Furthermore, when a match-making is established, execution of the battle game concerning the external service can be triggered. Furthermore, a monitor object 702 is also placed in the normal battle room as described below, and an enjoyable element that can be enjoyed by users who have entered the room and for whom any match-making has not been established, is presented by the monitor object 702.

### (Special Battle Room)

In contrast, the special battle room is a virtual space, for example, in which only a particular user invited by an administrator or an event organizer can perform a match-making. Unlike the normal battle room, the special battle room is configured such that only a pair of users (hereinafter, referred to as invited players) can perform match-makings. However, an ability to enter the special battle room is not limited to the invited players but is granted to other users as well. If a user other than the invited players enters the special battle room, the user is treated as a spectator. That is, the special battle room is a virtual space used for the purpose that a battle game played by invited players such as an exhibition match is spectated by users who have entered the room other than the invited players.

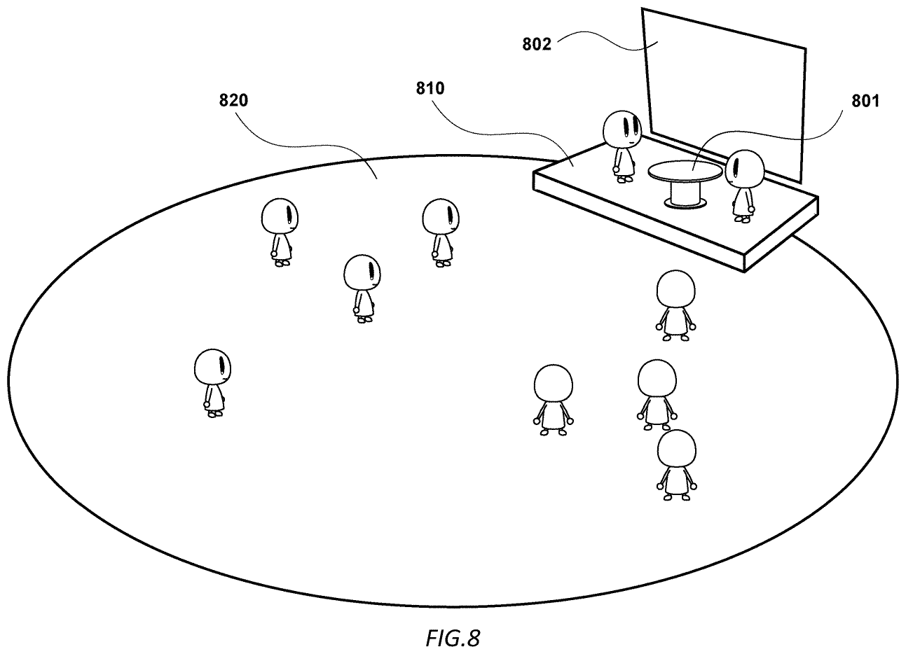

Therefore, the special battle room is mainly divided into a region of a stage 810 where avatars of the invited players are movable and a region of a spectator floor 820 where avatars of the spectators are movable, as illustrated in FIG. 8. Only one table object 801 for the special battle room is placed on the stage 810, and the table object 801 is controlled such that only the invited players can move their operable avatars near the table object 801 and perform every kind of procedure concerning the match-making. Furthermore, a monitor object 802 is placed behind (to be farther than) the table object 801 on the stage 810 when seen in a direction toward the stage 810 from the spectator floor 820, and similarly to the normal battle room, an enjoyable element that can be enjoyed by spectators as well is presented by the monitor object 802.

(Transition from Entrance Room)

Next, entering the normal battle room and special battle room from the entrance room, i.e., transition between rooms, will be described.

Since each of the battle rooms is used by a plurality of users simultaneously, information on each of the users to whom each room is assigned is managed at the server 200. On the other hand, for each battle room, an operation input performed by each user within the room at their user terminal 100, such as a movement or match-making request, needs to be acquired and shared among user terminals 100 concerning users in the same room. Thus, since processing load concerning such sharing increases as a number of users entering one battle room becomes greater, an upper limit number needs to be provided for a number of users one battle room can accommodate. Meanwhile, it is assumed that a greater number of users than the upper limit number simultaneously use the match-making service at the time of a day during which the service is assumed to be used by many users or at the time of some event, for example.

Therefore, the server 200 of the present embodiment is configured to be able to manage one or more rooms for each of the normal battle room and the special battle room. In other words, the match-making service is configured to be able to provide a plurality of rooms as the normal battle room and provide a plurality of rooms as the special battle room. In the below, in order to distinguish between the “normal battle room” or the “special battle room” as the type of virtual space and the “room” as a unit virtual space for managing users whose avatars are placed therein, the latter is referred to as a “chamber”. That is, in the match-making service, a plurality of chambers as the normal battle room and a plurality of chambers as the special battle room are provided respectively.

As described above, in the entrance room, a user can, from the destination selection image 600 displayed in response to their operable avatar being moved near the window object 501, issue a placement request to place the operable avatar into a battle room of the type they selected. From the destination selection image 600, the user first selects whether the type of battle room they desire to enter is the normal battle room or the special battle room, wherein a plurality of chambers are provided for each battle room. For this reason, the following two types of aspects of the placement request in the match-making service of the present embodiment are provided, and a user needs to select either aspect as an option for the placement request.

One aspect of the placement request is an automatic placement request to cause the server 200 to determine which chamber of the battle room of the specified type the user enters. Upon the automatic placement request, the server 200, or the server control unit 201 thereof, selects one chamber for the user to enter from a plurality of chambers provided as the battle room of the applicable type and guides the user to the selected chamber. As the chamber for the user to enter, a chamber which another user has already entered is preferentially selected, such that the user is suitably given an opportunity for a match-making. In the present embodiment, the server 200 selects a chamber having a greatest number of users who have entered there as the chamber for the user who issued the placement request to enter. Here, an upper limit number is set for a number of manageable users (a number of placeable avatars) for each chamber, and the server 200 excludes any chamber where the upper limit number of users have entered to select a chamber to enter. In this manner, it is possible to reduce situations where a user has entered a chamber but there are no/few other users who could be opponents in the chamber. Note that, in the situation where no users have entered any chambers, a user who has issued a placement request may be guided to a chamber with no other users.

Another aspect of the placement request is a specified placement request in which a user specifies the type of the battle room and the room to enter. The specified placement request is transmitted to the server 200, subject to information for specifying a destination chamber being further inputted at the user terminal 100. More specifically, the specified placement request includes a placement request specifying an existing chamber as the destination chamber, and a placement request generating a new chamber and specifying the new chamber as the destination chamber.

To each chamber provided for the normal battle room and the special battle room, an identification for uniquely identifying the chamber, i.e., a chamber ID, is set. The chamber ID is set upon chamber generation, and in the present embodiment, it is in the form of text-type information. Here, the generation of a chamber concerning the battle room may be carried out by the server 200 depending on a number of users being logging into the service, or may be carried out, for example, based on a generation request to generate a chamber from a user who plans and manages individual tournaments and events (hereinafter referred to as a host). As the chamber ID, one determined by the server 200 is used in the former case, and one specified by the host is used in the latter case.

A different rule is defined for each text that can be set as a chamber ID, such that the normal battle room and the special battle room can be easily distinguished. In an aspect, an English word regarding a fruit, such as “banana”, “melon”, or “orange”, is defined as the chamber ID that can be set for the normal battle room, and an English word regarding an animal, such as “dog”, “cat”, or “elephant”, is defined as the chamber ID that can be set for the special battle room. Text information that can be specified as such a chamber ID may be managed, for example, with reference to dictionary data storing the applicable text. In this aspect, when the server 200 generates a chamber without any generation request by the host, text currently not being used is acquired from the applicable dictionary data to set it as a chamber ID. Furthermore, when a chamber is generated by a generation request by the host, if text input by the host for the chamber ID is registered in dictionary data concerning the battle room of the applicable type, a chamber with the text set as its chamber ID is generated. It is enough if information regarding what rule text that can be set as the chamber ID complies with is presented to a user (host), for example, on a menu screen displayed for a specified placement request including a new creation request, etc.

That is, when the server 200 receives a specified placement request for an already generated chamber, namely, a specified placement request that does not include a generation request to generate a new chamber, it causes the user to enter a chamber to which the chamber ID included in the specified placement request is set. In contrast, when server 200 receives a specified placement request that includes a generation request to generate a new chamber, it first checks that there does not exist a chamber to which the chamber ID included in the specified placement request is set. If the applicable chamber does not exist, then, subject to the chamber ID meeting the rule defined for the battle room of the selected type, the server 200 generates a chamber to which the chamber ID is set and causes the user to enter the chamber. In this manner, for example, when a plurality of people want to use the match-making service together, etc., these users can generate any chamber or enter a particular chamber, rather than a chamber automatically selected by the server 200.

### (Match-Making)

In each battle room, a match-making for the battle game concerning the external service can be established between users whose avatars are placed in a same chamber (match-making function). In the match-making service of the present embodiment, a match-making can be performed through a table object placed within the chamber. First, a match-making in a chamber of the normal battle room will be described below with reference to the figures.

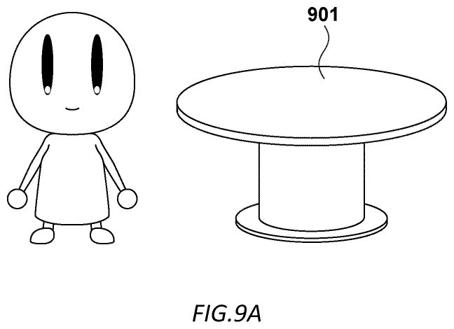

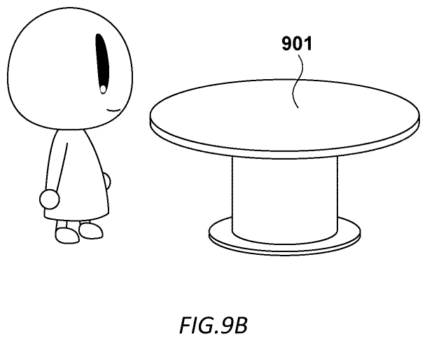

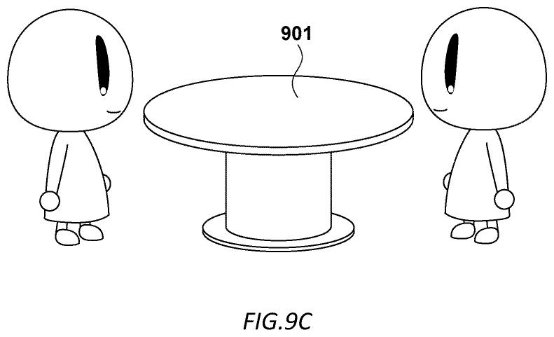

A user who wants to wait for a battle offer from another user moves their operable avatar near a table object 901 within the chamber as illustrated in FIG. 9A. When the operable avatar is placed near the table object 901, the user is enabled to perform an operation input to the table object 901. When an operation input to the table object 901 is performed at the user terminal 100 used by the user, then, for example, after a confirmation to transition to a match-making standby state is displayed, a standby request is transmitted to the server 200. The standby request may include, for example, an identification for uniquely identifying an instance of the table object 901 (a combination of a chamber ID and a table ID) and an identification for uniquely specifying the user. When the server 200 receives the standby request, it updates a state of the user into the match-making standby state and transmits the information to a user terminal 100 of another user who has entered the same chamber.

When the operable avatar of the user gets into the match-making standby state, it is displayed in a state of being around the table object 901 as illustrated in FIG. 9B. The display is continued until the user performs an operation input concerning a standby cancellation or the battle game performed following the establishment of the match-making ends. That is, the operable avatar of the user in the match-making standby state is displayed as a state of not being moved from the location of the table object 901 in the chamber. In the match-making standby state, the operable avatar is controlled not to be moved even when the user performs an operation input concerning the movement of the operable avatar.

The table object 901 which an avatar of one user has being around to get into the match-making standby state (hereinafter, referred to as a standby table), is enabled to accept a battle offer from another user. Therefore, a user who wants to offer a battle can move their operable avatar near the standby table and perform an operation input concerning the standby table, to offer a battle to a user (hereinafter, referred to as a waiting person) of an avatar who has already been around the standby table (hereinafter, referred to as a waiting avatar). Specifically, when the operation input to the standby table is performed at a user terminal 100 used by the user who offers a battle (hereinafter, referred to as an offeror), then, for example, after a confirmation to offer a battle is displayed, a match-making request is transmitted to the server 200. The match-making request may include, for example, an identification for uniquely specifying the standby table, an identification for uniquely specifying the waiting person, and an identification for uniquely specifying the offeror. When the server 200 receives the match-making request, it temporarily updates a state of the offeror into the match-making standby state and transmits the information to a user terminal 100 of another user who has entered the same chamber.

When the offeror gets into the match-making standby state, as illustrated in FIG. 9C, an operable avatar of the offeror (hereinafter, referred to as an offering avatar) is also displayed as a state of being around the standby table, with the offering avatar and the waiting avatar facing each other over the table object 901. The display is continued until the offeror performs an operation input concerning a cancellation of the battle offer, the waiting person inputs an operation concerning an offer decline, or the battle game performed following the establishment of the match-making ends. That is, the offering avatar in the match-making standby state is displayed as a state of not being moved from the location of the standby table in the chamber. In the match-making standby state, the offering avatar is controlled not to be moved even when the offeror performs an operation input concerning the movement of the offering avatar.

In this manner, when the waiting avatar and the offering avatar get into the state of being around the table object 901 with facing each other, an inquiry of whether to accept the battle offer from the offeror is transmitted from the server 200 to a user terminal 100 of the waiting person. The waiting person can perform an operation input concerning an acceptance/decline of the battle offer by the offeror. When the battle offer is accepted by the waiting person, the server 200 executes a process for a match-making between the waiting person and the offeror to establish the match-making. Then, during the match-making, the server 200 updates information on states of both users it manages. Furthermore, in response to the establishment of the match-making, the waiting person and the offeror may be managed as “players”.

In a chamber of the normal battle room, a match-making between users who have entered the same chamber is configured to be enabled in such a procedure at a table object placed within the chamber. That is, in each chamber of the normal battle room, at most a same number of match-makings as a number of table objects placed in the chamber can be performed during a same period. In other words, in the normal battle room, if a user moves their operable avatar near a table object and performs an operation input to the table object, then they can cause the server 200 to execute a process regarding the match-making.

In contrast, the special battle room is controlled such that only a particular user can perform a match-making as described above. Therefore, in a chamber of the special battle room, every kind of request from a user concerning a match-making which occurs through a table object provided on the stage, is enabled subject to the user satisfying a participation condition on a battle game of an external service triggered using the special battle room. In other words, for example, since only users invited by an organizer or the like can be players in the special battle room, it is determined whether or not a user is the invited user when the user causes their operable avatar to approach the table object and issues a match-making standby request or a match-making request. The determination may be made at the user terminal 100 used by the user, or may be made at the server 200, which has received the request.

Therefore, a match-making in the normal battle room and a match-making in the special battle room differ in that the latter is performed subject to users satisfying a predetermined participation condition, while the former is performed without such a condition.

### (Battle Game)

When a match-making is established in a chamber of each battle room, the server 200 transmits, to a gaming server not shown concerning the external service, a creation request to create a connection destination of the battle game along with information on the two players (the waiting person and the offeror) for whom the match-making is established. The gaming server creates a connection destination concerning a new battle game according to the creation request and returns information on the connection destination to the server 200. Then, the server 200 transmits the returned information on the connection destination to each user terminal 100 used by each player, along with a forwarding instruction. At the user terminals 100, which have received the forwarding instruction, a connection to the connection destination is triggered on the browser, and its view is switched from the match-making service to the external service. In this manner, even when each player does not conduct any registration procedure or the like for the external service directly on their own, they can start a battle game with their opponent player with whom the match-making has been established in the match-making service.

In the present embodiment, in order to be able to readily resume the match-making service after the battle by each player ends, a logged-in state of the match-making service is maintained during transition to the external service (while the battle game in the external service is being played) as well. More specifically, for example, if information on a connection destination concerning the external service is received at the user terminal 100 of each player, then another tab of the browser (or another window) is opened, a connection to the connection destination is made, and the tab is mainly displayed (selected as a display tab, or the another window is displayed as a frontmost window), which achieves an temporal transition from the match-making service to the external service. At this time, since the tab concerning the match-making service exists also during the transition, each player can also check a status of the chamber concerning the match-making service and a play screen of the battle game concerning the external service in parallel.

As described above, the battle game concerning the external service for which the match-making system of the present embodiment performs a match-making between players, is a TCG. To be concise, in the TCG, each player constructs a deck using game cards that are real items; acquires some game cards as their initial hand from the deck that has been shuffled; and progresses the game by, at their turn, adding a game card from the deck to their hand, and by placing a card from their hand to a field as necessary or declaring an action of the card placed to the field to cause the intended player to perform every kind of operation concerning a solution to the declaration. Therefore, for the progression of the battle game, it is essential to be able to check the state of each player's field, i.e., game field. For this reason, the battle game performed using the external service progresses while videos obtained by capturing each player's hands and voices of declarations by each player are shared to each other using a video chat function.

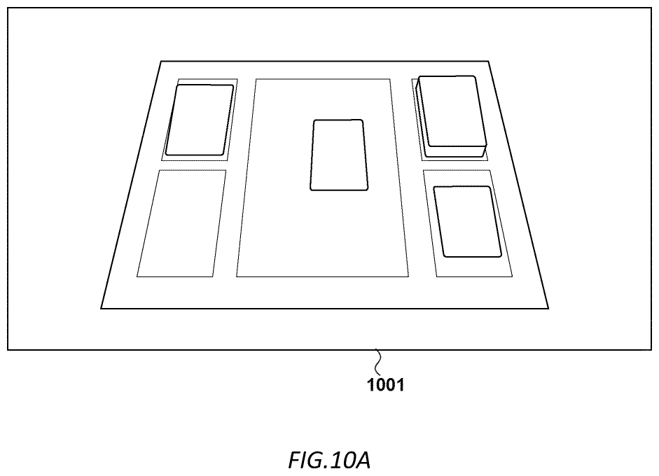

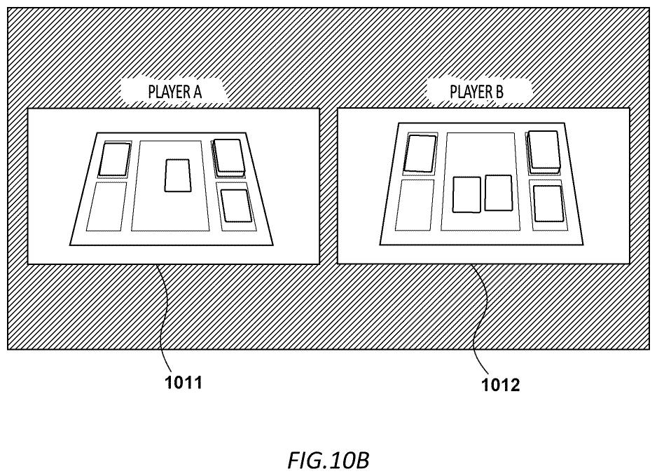

The screen displayed on the user terminal 100 used by the player while the gameplay is in progress, i.e., the play screen, may display a real-life video 1001 as it is, which is captured by the user terminal 100 used by the opponent, for example, as illustrated in FIG. 10A. Although the example of FIG. 10A illustrates an aspect where the video 1001 captured by the user terminal 100 used by the opponent is displayed as it is in a full-screen view, the play screen may be configured such that frame images of the video 1001 are placed with a predetermined GUI.

When the battle game concerning the external service ends, the view on the user terminal 100 used by each player resumes to display the match-making service from the external service. Information regarding the fact that usage of the external service by the players has ended (end information) may be transmitted from the user terminal 100 of at least either of the players to the server 200, or may be transmitted directly from the gaming server concerning the external service to the server 200. The end information includes information on a result of the battle game (win or lose). The server 200 transmits information for displaying the result of the battle game along with a display request to the user terminal 100 used by each player in order to display the result of the battle game to each player based on the received end information. When the user terminal 100 of each player receives the information, it displays the result of the battle game played using the external service.

Furthermore, when the server 200 receives result information concerning the battle game played between the players, it updates states of the applicable users from a match-making state into a free state. The avatar of each user changed into the free state leaves the state of being around the table object, and gets into a state of being movable within the chamber of the battle room in response to an operation input being performed at the user terminal 100 used by the user in a similar manner to before getting into the match-making standby state.

### (Game Spectating and Spectating Effect)

In the match-making service of the present embodiment, a function concerning spectating a battle game played through a chamber of a battle room is provided as an enjoyable element that a user can enjoy without attempting any match-making while being in the chamber.

An aspect of a spectating function enabled using the match-making service is executed through a monitor object placed within the chamber of the battle room. The monitor object is a plate-shaped object placed, at least one for each chamber, and can be used for displaying information by applying different textures to its flat portion (hereinafter, referred to as an information display portion). In the match-making service of the present embodiment, a play video concerning a battle game currently being played by players within the chamber in which the monitor object is placed is displayed on the information display portion of the monitor object. That is, the server 200 can sequentially receive information of a video of hands concerning one player in the match-making state within the chamber from the gaming server of the external service, and transmits its frame images to the user terminal 100 of the user being in the same chamber as the textures to be displayed on the information display portion, to present them through the monitor object. Here, as the textures applied to the information display portion, a video of hands obtained by focusing on one player as illustrated in FIG. 10A may be used, or an image configured to include videos of hands of both players during the battle as illustrated in FIG. 10B may be used.

In this aspect, it is required that a match-making between users is performed using any of the table objects within the chamber and a battle game is currently being played between them, although display of information through the monitor object is not limited thereto. The video displayed on the information display portion of the monitor object may be a play video of the game played in the past by any of the users in the chamber or a play video of the battle game played in the past and selected by the administrator, such as of final round of an event, or may be a part of a play video of a battle game, e.g., an edited version of some part of interest or the like. Alternatively, the monitor object may also display a promotional video (PV) of a battle game content or the like in order to make the battle game content more exciting.

Furthermore, especially in an aspect where a play video is displayed, in order to spread the enjoyability of spectating a game to each user, an avatar placed near the monitor object may be compulsorily set to and displayed in a mode in which the avatar views the monitor object during a period when the video is displayed on the information display portion of the monitor object.

Furthermore, in order to make it easy to check the monitor object, when a user performs an operation input to the monitor object, camera parameters concerning rendering of the chamber, i.e., the three-dimensional space, may be controlled and changed such that a whole of the monitor object is displayed within a display range of the user terminal 100. In this case, to return from the view focused on the monitor object to a normal view, for example, the camera parameters may also be configured to be changed (to return to a mode in which the monitor object is not focused) when an operation input to the operable avatar is accepted.

Furthermore, in an aspect where users who have entered the chamber can be classified into a player (a user who can move their avatar to the stage to perform a match-making) and a spectator (a user whose avatar moves only in the spectator floor and is unable to perform any match-making) as in the special battle room, their spectating modes may be made different to each other. That is, since a user who enters a chamber of the special battle room as a spectator has a purpose of spectating a battle game, the operable avatar corresponding to the spectator may be compulsorily set to and displayed in a mode in which the operable avatar views the monitor object on the stage at least during a period when the battle game triggered in the same chamber is being played.

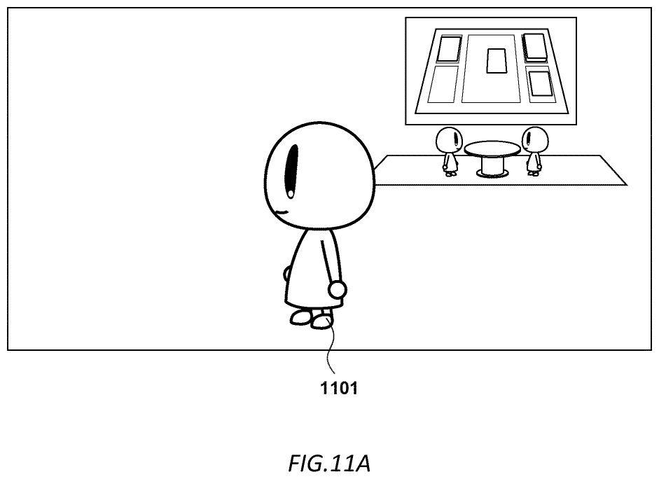

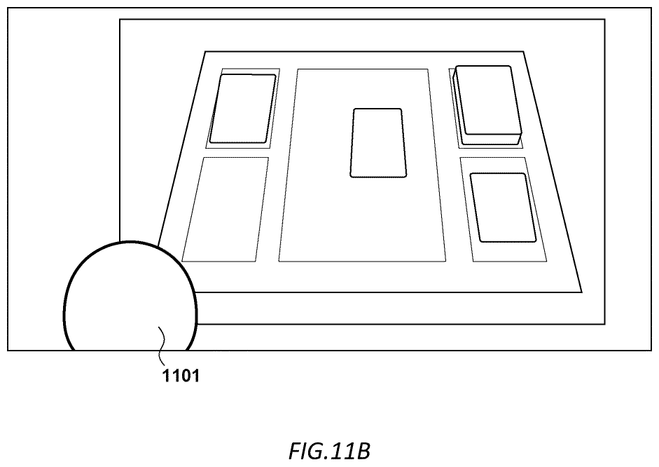

Furthermore, camera parameters concerning rendering of the chamber, which are set at the user terminal 100 used by the spectator, may be controlled to be set such that the operable avatar and the monitor object on the stage are always displayed, as illustrated in FIG. 11A and FIG. 11B. FIG. 11A illustrates a view during a period when an operable avatar 1101 is operated to move by a spectator. At this time, the operable avatar temporarily leaves a mode in which the operable avatar views the monitor object to explicitly indicate a movement direction. Furthermore, the camera parameters are set such that a whole of the operable avatar and the monitor object are included within the display range to explicitly indicate a destination. On the other hand, FIG. 11B illustrates a view during a period when the operable avatar is not operated to move by the spectator. At this time, the camera parameters are set such that only a part of the operable avatar 1101 is displayed to make the information display portion of the monitor object easier to be seen.

Note that a play video through the information display portion of the monitor object may not be ideally viewed, for example, when an occlusion occurs due to an avatar of another user placed in front of the monitor object or the like. For this reason, the match-making service may also include a function for viewing the play video in a full-screen view for a user who wants to view a battle game more elaborately. The viewing function in the full-screen view may be executed by temporarily transitioning the user terminal 100 of the user into the external service, or may be executed by displaying frame images of a play video, which the server 200 has received from the gaming server concerning the external service and forwarded to the user terminal 100, in the full-screen view.

Furthermore, in the viewing function in the full-screen view, when the operable avatar is closer to the monitor object than a predetermined distance, the view on the user terminal 100 may be switchable to the full-screen view of the play video in response to accepting an operation input to the monitor object and fulfilling the operation input. Furthermore, in the normal battle room, since a plurality of table objects are placed and match-makings for the battle game are possible, a play video presented using the monitor object is not necessarily that of a particular battle game a user wants to spectate. For this reason, in the normal battle room, the view on the user terminal 100 of the user may be switchable to the full-screen view of the play video of the battle game concerning the table object in response to performing an operation input to the table object at which a match-making has been established by the users. In this case, for example, the operable avatar of the user is controlled to be displayed to other users in the mode in which the operable avatar views the table object when the operable avatar is near the table object.

Furthermore, in order to make the spectating experience within the chamber of the battle room more realistic, for example, while a battle game is being played, an effect may also be applied in which an object related to the battle game (in the present embodiment, a card object corresponding to the game card) is placed and displayed on the table object at which the match-making has been established.

### (Staff Member Avatar)

The user of the match-making service can include not only a general user with a purpose of performing a match-making for the battle game concerning the external service but also a user belonging to the administrator of the service or an event. The user belonging to the administrator includes, for example, a staff member who supports a user who is not familiar with using the service, or a staff member who polices a user who uses the service inappropriately. Hereinafter, the user belonging to the administrator is simply referred to as a staff member, and an avatar operated by the user is referred to as a staff member avatar. Furthermore, an avatar concerning the general user is distinctly referred to as a general avatar, as necessary. The staff member and the general user may be configured to be distinguishable based on whether or not a staff member attribute is given to user information in a user DB, not shown, which is managed in the server 200.

When a staff member logs into the service, a staff member avatar is placed in the entrance room as with the general user. In the entrance room, an appearance of the staff member avatar can be changed. Here, since it is preferable that the staff member avatar is distinguishable from the general avatar in the battle room, rendering elements that can be selected for its appearance (such as color of the avatar or a wearable item) differ from those for the general avatar, i.e., they are unable to be selected by the general user.

The staff member can move the staff member avatar near the window object in the entrance room to use a user interface for selecting a battle room as the destination. Here, the user interface available to the staff member may be similar to the one available to the general users, as illustrated in FIG. 6, although it may also be configured such that, for example, only a specified placement request is possible because it is for administrative purposes. When a specified placement request to a chamber of a particular chamber ID is issued by the staff member, the server 200 controls the staff member to be able to enter the chamber even when a number of general users in the chamber reaches an upper limit number. This is because, even when the chamber is full to capacity, there may exist a general user who desires some support.

Upon entering each chamber of the battle room, the staff member can perform an operation input concerning a movement to move the staff member avatar within the chamber. In the chamber of the battle room, the staff member is not given a usage permission for the match-making function of the battle game. This is achieved, for example, by controlling such that any operation input concerning a match-making standby request is not accepted even if the staff member avatar is placed near the table object, or by controlling such that the staff member does not perform any match-making process based on the match-making request from the general user when the staff member gets into the match-making standby state for maintenance.

Furthermore, in the chamber of the battle room, the staff member is not given the usage permission for the match-making function of the battle game, but instead is given an execution permission for a function that is not given to the general user. The function includes, for example, a function for forcing a specified general user to leave a chamber, or a function for guiding a general user to a standby table. Furthermore, in order to monitor inappropriate service usage or maintain an atmosphere of events held using the special battle room, the staff member may be given an execution permission for a function for enabling them to place their staff member avatar in the chamber of the battle room in an invisible manner.

### (Communication Function)

Furthermore, each chamber of the battle room is configured such that a function for communicating between users in the chamber is available.

One aspect of the communication function is a text chat function. The text chat function is achieved by the server 200 acquiring text information (comment information) input by an user who has entered one chamber of the battle room at the user terminal 100 used by the user, and distributing (sharing) the comment information to each user terminal 100 such that all users who have entered the same chamber can view the comment information. A history of comments made in the chamber is displayed on a text chat window or the like displayed along with the virtual space on each user terminal 100 and configured to be able to be viewed by each user who has entered the same chamber. Alternatively, the history of comments may be displayed through the monitor object placed within the chamber. Displaying all the history of comments would make viewability at the user terminal 100 deteriorate, the history of comments may be configured such that, for example, texts are arranged in chronological order, with the most recent text being at the top and texts posted longer time ago being at the lower places, and texts older than a predetermined line are not displayed or are viewable by scrolling.

The text chat function is configured to be available to the staff member, and, for example, can be used to notify general users who have entered the same chamber of a warning, a necessary announcement, or the like. A comment made by the staff member is preferentially displayed at the top or other places in the history of comments displayed on the text chat window or the like, in order to prevent the general user from overlooking it.

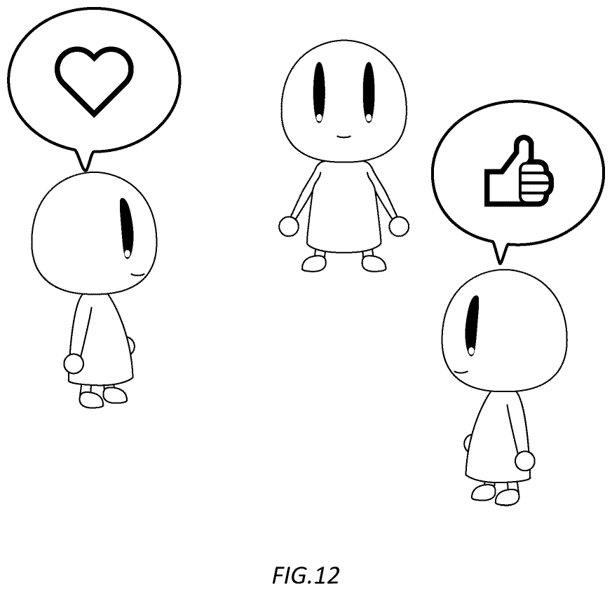

Another aspect of the communication function is an emote display function. The emote display function is achieved by the server 200 acquiring emote information, for example, an emoji such as thumbs-up or heart, input by an user who has entered one chamber of the battle room at the user terminal 100 used by the user, and distributing (sharing) the emote information to an intended user terminal 100 such that an intended user who has entered the same chamber can view the emote information. The display of the emote information is made in a manner that an emoji is displayed in a speech bubble above a head of the operable avatar of the user who inputted an emote, as illustrated in FIG. 12, for example. However, it is preferable to display such speech bubbles in a limited manner, since, if they were displayed all over the chamber, the computational load would be excessive due to an increase in a number of displayed objects. In the match-making service of the present embodiment, an emote input by a user is displayed in a limited manner to users whose avatars are placed within a predetermined distance range from the operable avatar corresponding to the user in question in the same chamber. That is, the server 200 identifies a user corresponding to the avatar whose placement location falls within a predetermined distance from a current location (coordinates in the chamber) of the operable avatar of the user who inputted an emote, and causes a user terminal 100 used by the user corresponding to the avatar to share and display the emote information along with information on the user who inputted it. Furthermore, the display of the emote information may be limited to within a certain duration from when the emote is input.

### «Entrance Process»

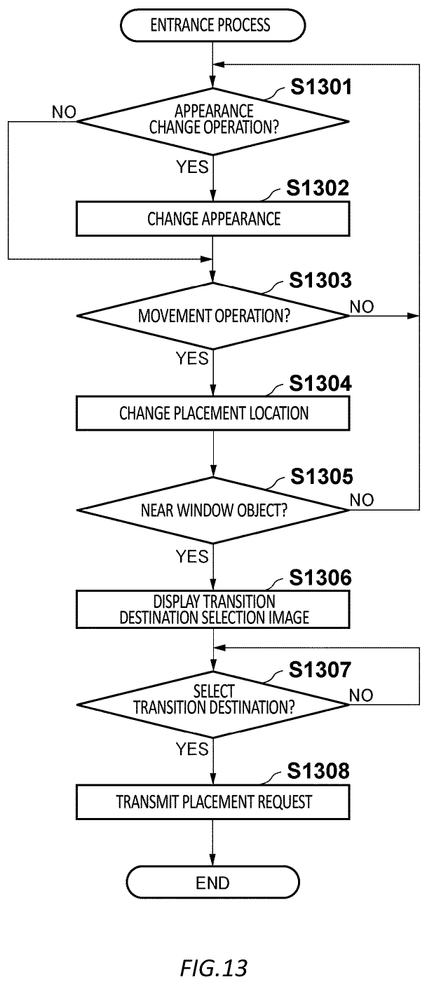

Now, an Entrance Process performed for the entrance room at the user terminal 100 of the present embodiment with such a configuration, will be specifically described with reference to a flowchart in FIG. 13. A process corresponding to the flowchart can be achieved, for example, by the control unit 101 reading a corresponding processing program stored in the storage 102 and deploying it to the memory 103 to execute. Note that the present entrance process is described as starting, for example, when service log-in of the match-making service is performed at the user terminal 100. Furthermore, in the present entrance process, the GPU 104 is described as repeatedly executing a process to render the three-dimensional space concerning the entrance room, the description of which is omitted in the flowchart below.

In S1301, the control unit 101 determines whether or not an operation input concerning a change in an appearance of an operable avatar is performed. If the control unit 101 determines that the operation input concerning the change in the appearance of the operable avatar is performed, the process proceeds to S1302; otherwise, the process proceeds to S1303.

In S1302, the control unit 101, based on the operation input concerning the change in the appearance being performed, changes the appearance of the operable avatar. Furthermore, the GPU 104, under control by the control unit 101, renders the operable avatar having the appearance after the change to display it on the display 110.

In 1303, the control unit 101 determines whether or not an operation input concerning a movement of the operable avatar is performed. If the control unit 101 determines that the operation input concerning the movement of the operable avatar is performed, the process proceeds to S1304; otherwise, the process returns to S1301.

In S1304, the control unit 101, based on the operation input concerning the movement, changes a placement location of the operable avatar.

In S1305, the control unit 101 determines whether or not the placement location of the operable avatar after the movement is within a predetermined distance from a window object. If the control unit 101 determines that the placement location of the operable avatar after the movement is within the predetermined distance from the window object, the process proceeds to S1306; otherwise, the process returns to S1301.

In S1306, the GPU 104, under control by the control unit 101, displays an image concerning selection of a battle room as a transition destination to the display 110.

In 1307, the control unit 101 determines whether or not the operation input concerning the selection of the battle room as the transition destination is performed. If the control unit 101 determines that the operation input concerning the selection of the battle room as the transition destination is performed, the process proceeds to S1308; otherwise, the present step is repeated. Note that, in the control unit 101, when an operation input concerning a display termination of the image concerning the selection of the battle room as the transition destination is performed, the process returns to S1301.

In S1308, the control unit 101, based on the operation input concerning the selection of the battle room as the transition destination, transmits a placement request concerning battle-room entrance by a user to the server 200 to complete the present entrance process.

In this manner, the user can set their appearance without being rushed in a space without any avatar concerning another user. Furthermore, the selection of the battle room to which they want to move can be performed in a manner with enjoyability.

### «Guidance Process»

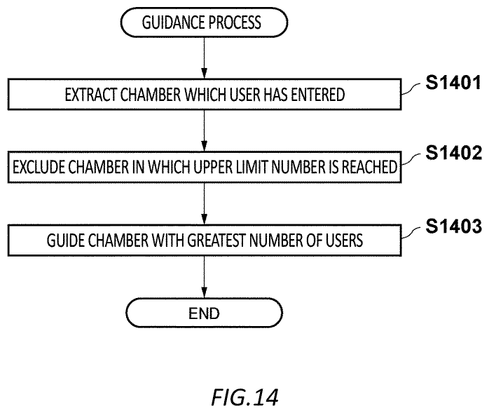

Next, a guidance process of causing a user to enter a battle room performed at the server 200 of the present embodiment, will be specifically described with reference to a flowchart in FIG. 14. A process corresponding to the flowchart can be achieved, for example, by the server control unit 201 reading a corresponding processing program stored in the server storage 202 and deploying it to the server memory 203 to execute. Note that the present guidance process is described as starting, for example, when an automatic placement request is received.

In S1401, the control unit 101 extracts chambers which a user has entered among chambers provided for a battle room of a type specified by the automatic placement request.

In S1402, the control unit 101 excludes any chamber which an upper limit number of users have entered among the chambers extracted in S1401.

In S1403, the control unit 101 selects one chamber having a greatest number of users who have entered there among the extracted chambers after the exclusion in S1402, and executes a process to cause the user who has performed the automatic placement request to enter the chamber, to complete the present guidance process.

In this manner, the user can be guided to the chamber of the battle room where a match-making is more easily established.

### «Monitor Display Process»

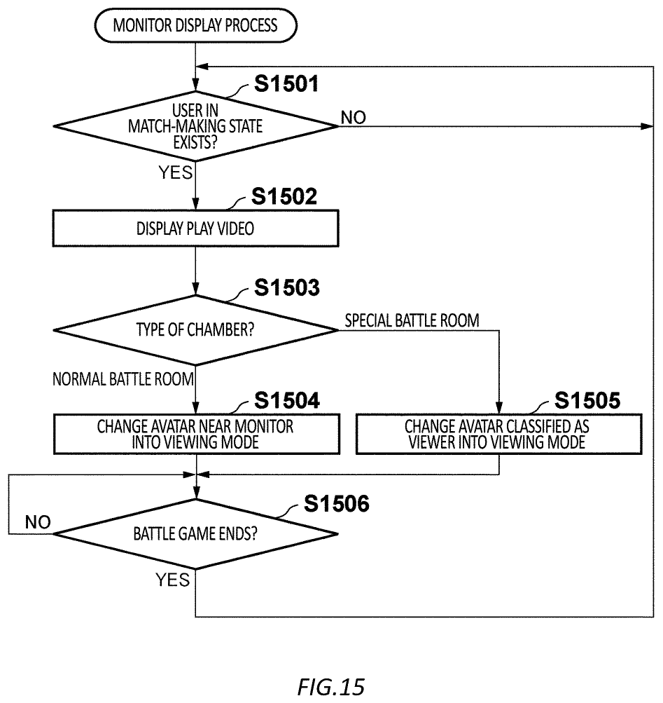

Next, a monitor display process of presenting information on the monitor object in the battle room at the user terminal 100 of the present embodiment, will be specifically described with reference to a flowchart in FIG. 15. A process corresponding to the flowchart can be achieved, for example, by the control unit 101 reading a corresponding processing program stored in the storage 102 and deploying it to the memory 103 to execute. Note that the present monitor display process is described as starting, for example, when the operable avatar of the user is placed in the chamber of the battle room (when the user enters the chamber). Furthermore, in the present monitor display process, the GPU 104 is described as repeatedly executing a process to render the three-dimensional space concerning the battle room, the description of which is omitted in the flowchart below.

In S1501, the control unit 101 determines whether or not a user (player) in a match-making state for whom a match-making has been established at the table object exists within the chamber. If the control unit 101 determines that the player in the match-making state exists within the chamber, the process proceeds to S1502; otherwise, the process of the present step is repeated.

In S1502, the GPU 104, under control by the control unit 101, sequentially applies and renders frame images of a play video concerning the player in the match-making state as textures on an information display portion of a monitor object within the chamber, to cause the display 110 to display the monitor object in a mode in which the monitor object presents the play video.

In 1503, the control unit 101 determines whether the chamber is a chamber of a normal battle room or a chamber of a special battle room. If the control unit 101 determines that the chamber is the chamber of the normal battle room, the process proceeds to S1504; if it determines that the chamber is the chamber of the special battle room, the process proceeds to S1505.

In S1504, the GPU 104, under control by the control unit 101, displays a screen obtained by changing a display mode of the avatar whose placement location is set near the monitor object into a mode in which the avatar views the monitor object and rendering the avatar, on the display 110.

On the other hand, when it is determined that the chamber is the chamber of the special battle room in S1503, in S1505, the GPU 104, under control by the control unit 101, displays a screen obtained by changing a display mode of the avatar of the user classified as a spectator into a mode in which the avatar views the monitor object and rendering the avatar, on the display 110.

In S1506, the control unit 101 determines whether or not the battle game played by the player in the match-making state ends. When the control unit 101 determines that the battle game ends, the process returns to S1501; otherwise, the process of the present step is repeated.

As described above, according to the match-making system of the present embodiment, it is possible to provide a convenient match-making service with improved enjoyability when using a virtual space.

### Embodiment 2

In the match-making service in the above embodiment, it has been described that a match-making for a battle game concerning one game content is performed, but the implementation of the present invention is not limited thereto. There may be a plurality of types of game contents for which a match-making can be performed through the match-making system, where at least every kind of battle room may be provided for each game content. A determination as to which game content's battle room a placement request is issued to may be made based on the user's intention in the entrance room, for example.

### (Variant 1)

In the embodiments described above, it has been described that the chamber of each battle room mainly provides the match-making function between users, the spectating function, and the communication function, but the implementation of the present invention is not limited thereto. Each chamber may be provided with, for example, a function for selling/purchasing relevant goods of the game content for which a match-making is provided. For example, when the battle game for which the match-making is provided is a TCG as described above, the sell/purchase function may be provided to sell/purchase real items (game cards) that can be used in the TCG. As the sell/purchase function, a payment procedure may be performed in the match-making service, or, for example, the sell/purchase function may be provided indirectly by transitioning the user terminal 100 to a sales page of appropriate goods on an EC website.

Furthermore, the relevant goods do not need to be real items, and may include, for example, in-game items, downloadable content, or the like.

### (Variant 2)

In the embodiments described above, it has been described that the entrance room is a virtual space in which the operable avatar of the user is placed alone, but the implementation of the present invention is not limited thereto. For example, in an aspect of group use or the like, the entrance room may be configured such that avatars of a plurality of users are placed therein.

### (Variant 3)

In the embodiments described above, it has been described that, when the operable avatar is placed near the window object in the entrance room, an image including an image of a facility imitating the battle room is presented to select a battle room as a transition destination. However, the implementation of the present invention is not limited thereto, for example, an image including an image obtained by rendering a three-dimensional space of the applicable battle room may be presented.

### (Variant 4)

In the embodiments described above, an aspect has been described in which, when the automatic placement request is issued, the chamber which a greatest number of users have entered is selected as the transition destination among chambers in which an upper limit number is not reached, the implementation of the present invention is not limited thereto. It is enough if a chamber with more users entered is selected preferentially over a chamber with less users entered, and the chamber that is the transition destination may be selected from the chambers in which a number of users entered exceeds a predetermined number.

### (Variant 5)

In the embodiments described above, it has been described that the battle game of the external service for which a match-making is provided in the match-making service is a TCG, but the implementation of the present invention is not limited thereto. The game for which a match-making is provided may be a battle game of another genre. Furthermore, the game for which a match-making is provided is not limited to a battle game, as long as the game is configured such that a plurality of users can participate, and the game is, for example, a game involving cooperative play. Furthermore, the game for which a match-making is provided does not need to be one performed using any external service, but may be a game provided as one function of the match-making service.

### (Variant 6)

In the embodiments described above, it has been described that a video presented on the information display portion of the monitor object in the battle room is a real-life play video, but the implementation of the present invention is not limited thereto. For example, depending on a genre of the game or how to execute, a video that is not a real-life video can also be presented as the play video.

### (Variant 7)

In the embodiments described above, it has been described that a procedure regarding a match-making request through a table object provided within a chamber of a battle room is possible, but the implementation of the present invention is not limited thereto. The procedure regarding the match-making request may be configured to be executable when an avatar is placed at a particular location provided within the chamber, not through any object, for example.

### (Variant 8)

In the embodiments and variants described above, it has been described that the virtual space provided in the match-making service is a three-dimensional space expressed by placing a three-dimensional model therein, but the implementation of the present invention is not limited thereto. For example, it goes without saying that the present invention is applicable to a two-dimensional space configured by placing a two-dimensional model therein as well.

### OTHER EMBODIMENTS

The invention is not limited to the above embodiments, and various variations and modifications thereof can be made within the scope of the invention.

### EXPLANATION OF REFERENCES

100: user terminal;
101: control unit;
102: storage;
103: memory;
104: GPU;
110: display;
105: operation I/F;
106: communication I/F;
120: image-capturing unit;
130: microphone;
140: speaker;
200: server;
201: server control unit;
202: server storage;
203: server memory;
204: server communication I/F;
300: network.

What is claimed is:

1. An information processing device which executes:
a display control process of displaying a virtual space in which virtual characters associated with users are movably placed and in which a match-making for a game in which a plurality of users participate is possible; and
a control process of, subject to an establishment of a match-making in the virtual space, triggering execution of the game,
wherein a virtual monitor is placed in the virtual space; and
in the display control process, a video regarding the game is displayed through the virtual monitor.

2. The information processing device according to claim 1, wherein the video regarding the game is at least either of a promotional video of the game or a play video of the game.

3. The information processing device according to claim 2, wherein the play video of the game is a play video of the game currently being played or a play video of the game played in a past.

4. The information processing device according to claim 3, wherein
the virtual space comprises a plurality of chambers in each of which the virtual monitor is placed; and
in the display control process, one chamber of the plurality of chambers is displayed, and a play video of the game played by a user whose virtual character is placed in the chamber is displayed through the virtual monitor in the chamber.

5. The information processing device according to claim 2, wherein the play video is a video obtained by capturing a real space.

6. The information processing device according to claim 2, wherein the play video is a video having a frame in which an image obtained by capturing a real space is included.

7. The information processing device according to claim 1, wherein, when the execution of the game is triggered in the control process, in the display control process, a screen of the execution of the game is displayed instead of the virtual space.

8. The information processing device according to claim 7, which further executes an input process of accepting an operation input for moving a virtual character associated with a user who uses the information processing device,
wherein a match-making for the game is established subject to a virtual character being placed at a predetermined location in the virtual space.

9. The information processing device according to claim 8, wherein
the virtual space comprises a plurality of chambers in each of which the virtual monitor is placed; and
a match-making for the game is established between users associated with a plurality of virtual characters placed in a same chamber, subject to the plurality of virtual characters being placed at the predetermined location in the chamber.

10. The information processing device according to claim 9, wherein the match-making for the game is established subject to the plurality of virtual characters being placed at the predetermined location with facing each other.

11. The information processing device according to claim 9, wherein, in the display control process, the plurality of virtual characters corresponding to the users for whom the match-making is established are displayed in a mode in which the plurality of virtual characters do not move from the predetermined location while the game concerning the match-making is being played.

12. The information processing device according to claim 9, wherein, when the match-making is establish between the users corresponding to the plurality of virtual characters placed at the predetermined location, in the display control process, a virtual character placed near the virtual monitor is displayed in a mode in which the virtual character views the virtual monitor.

13. The information processing device according to claim 8, wherein, when the operation input for moving is accepted, in the display control process, the virtual character associated with the user who uses the information processing device is displayed moving the virtual space with an up-and-down motion of at least a part of an element constituting the virtual character.

14. The information processing device according to claim 1, wherein
the virtual characters placed in the virtual space comprise a first type character for which a match-making is possible and a second type character for which a match-making is impossible; and
in the display control process, a history of comments representing a comment by a user corresponding to the first type character and a comment by a user corresponding to the second type character is further displayed.

15. The information processing device according to claim 14, wherein, in the display control process, the comment by the user corresponding to the second type character is displayed in the history of comments preferentially over the comment by the user corresponding to the first type character.

16. The information processing device according to claim 1, wherein the virtual space, the virtual monitor and the virtual characters are configured in a form of a three-dimensional model.

17. The information processing device according to claim 16, which further executes a process of accepting an operation input to the virtual characters or the virtual monitor,
wherein, in the display control process, subject to the operation input to the virtual characters or the virtual monitor being performed, a display range of the virtual spaces is changed.

18. The information processing device according to claim 12, wherein the video regarding the game is a play video of the game currently being played by a user for whom a match-making is established, the play video being captured by the user for whom the match-making is established.

19. A non-transitory computer-readable storage medium having a program stored therein, wherein the program causes a computer to execute:
a display control process of displaying a virtual space in which virtual characters associated with users are movably placed and in which a match-making for a game in which a plurality of users participate is possible; and
a control process of, subject to an establishment of a match-making in the virtual space, triggering execution of the game,
wherein a virtual monitor is placed in the virtual space; and
in the display control process, a video regarding the game is displayed through the virtual monitor.

20. A match-making system comprising an information processing device used by a user; and a match-making server which executes a match-making process for a game in which a plurality of users participate, wherein the information processing device comprises:
a display control unit which displays a virtual space in which virtual characters associated with users are movably placed and in which a match-making request to the match-making server can be accepted; and
a control unit which, subject to an establishment of a match-making by the match-making server, triggers execution of the game,
wherein a virtual monitor is placed in the virtual space; and
the display control unit displays a video regarding the game through the virtual monitor.
